(19) United States
(12) Patent Application Publication
(10) Pub. No.: US 2003/0056769 A1
(43) Pub. Date: Mar. 27, 2003

(54) Fuel pressure regulator assembly for fuel delivery module

(76) Inventors: Dennis P. McGrath, Ortonville, MI (US); Ulf Sawert, Grand Blanc, MI (US); Grover W. Preston, Livonia, NY (US); Carlos A. Gutierrez, Pittsford, NY (US)

Correspondence Address: VINCENT A. CICHOSZ, DELPHI TECHONOLOGIES, INC., Legal Staff, Mail Code: 480-414-420, P.O. Box 5052, Troy, MI, 48007-5052, US

(21) Appl. No.: 10/122,508

(22) Filed: Apr. 15, 2002

Related U.S. Application Data
(60) Provisional application No. 60/323,905, filed on Sep. 21, 2001.

(51) Int. Cl. F02M 37/04

(52) U.S. Cl. 123/509; 123/511

(57) ABSTRACT

A fuel pressure regulator assembly for a fuel delivery module of a fuel system of a vehicle includes a housing having a cavity therein and a valve seat extending into the cavity and a passageway extending through the valve seat. The fuel pressure regulator assembly also includes a movable piston disposed in the cavity of the housing and a seal connected to the piston and disposed between the piston and the valve seat. The fuel pressure regulator assembly further includes a biasing mechanism disposed in the cavity to bias the piston and the seal toward the valve seat to close the passageway.

### CROSS-REFERENCE TO RELATED APPLICATION(S)

The present invention claims the priority date of copending U.S. Provisional Patent Application Serial No. 60/323,905, filed Sep. 21, 2001.

### TECHNICAL FIELD

The present invention relates generally to fuel systems for vehicles and, more particularly, to a fuel pressure regulator for a fuel delivery module for a fuel system of a vehicle.

### BACKGROUND OF THE INVENTION

It is known to provide a fuel system for a vehicle, which includes a fuel delivery module having an electrical fuel pump, a fuel filter, a fuel pressure regulator, a fuel rail, and fuel injectors. In a recirculating fuel system, all of the flow from the fuel pump is sent forward to the engine. The pressure regulator is located on the fuel rail, and the fuel not consumed by the engine is returned via a return line to the fuel tank. The returning “hot” fuel elevates the temperature of the bulk fuel in the fuel tank and contributes to the generation of vapors/running losses. These types of regulators are known as “by-pass” fuel regulators.

To eliminate the return of the “hot” fuel to the fuel tank, the fuel system was redesigned to a “returnless” fuel system. In the returnless fuel system, the fuel pressure regulator is relocated in the fuel tank and the return line is either completely or partially eliminated. However, the fuel pressure regulators being used inside the fuel tank are of the same type used on the fuel rail of a “hot” engine. As such, these fuel pressure regulators do not take advantage of the “protected” and less severe environment inside the fuel tank.

The “exposed” mounting position and high operating temperatures of rail mounted fuel pressure regulators have forced the use of ferrous or stainless steel components. Even minimal leakage has the potential of catastrophic failures on a rail mounted fuel pressure regulator, while the same failure in a fuel pressure regulator mounted inside the fuel tank may cause only a minimal impact on the vehicle. In contrast, fuel pressure regulators mounted on the engine do not create objectionable noise, while noise generated by a fuel pressure regulator mounted inside a fuel tank has the potential of creating customer dissatisfaction since the fuel tank acts as an amplifier similar to that of a loudspeaker.

Typical fuel pressure regulators use reinforced elastomer diaphragms, which are retained in the fuel pressure regulator using a crimping process. This process forms or rolls a metal edge of a housing over a perimeter surface of the diaphragm and retains it under very high compressive load. This compressive load is needed as the full surface area of the diaphragm is acted on by fuel at system pressure, typically 400 kpa, creating substantial force to pull the diaphragm out of the crimp joint. Many diaphragms fail due to the effects of pressure induced material stress and chemical induced material swell. Clearly, the diaphragm in current fuel pressure regulators is a highly stressed component requiring complex and expensive tooling to support production since automated assembly systems that produce these devices utilize hard steel tooling that produces only one “version” of the finished product and allows for little or no variation. Component part count for exiting regulators averages fifteen pieces. Attachment of this type of fuel pressure regulator to the fuel delivery module disposed in the fuel tank requires the use of a regulator adaptor. This additional component adds cost and complexity to the final assembly.

It is desirable to provide a new fuel pressure regulator assembly for a fuel delivery module in a fuel system for a vehicle. It is also desirable to provide a fuel pressure regulator assembly disposed in a fuel tank that is less complex and costly. It is further desirable to provide a fuel pressure regulator assembly for a fuel delivery module that requires fewer component parts. Therefore, there is a need in the art to provide a fuel pressure regulator assembly for a fuel delivery module of a fuel system that meets these desires.

### SUMMARY OF THE INVENTION

It is, therefore, one object of the present invention to provide a new fuel pressure regulator assembly for a fuel delivery module of a fuel system of a vehicle.

It is another object of the present invention to provide a fuel pressure regulator assembly for a fuel delivery module for a fuel system of a vehicle that is disposed within a fuel tank.

To achieve the foregoing objects, the present invention is a fuel pressure regulator assembly for a fuel delivery module of a fuel system of a vehicle including a housing having a cavity therein and a valve seat extending into the cavity and a passageway extending through the valve seat. The fuel pressure regulator assembly also includes a movable piston disposed in the cavity of the housing and a seal connected to the piston and disposed between the piston and the valve seat. The fuel pressure regulator assembly further includes a biasing mechanism disposed in the cavity to bias the piston and the seal toward the valve seat to close the passageway.

One advantage of the present invention is that a new fuel pressure regulator assembly is provided for a fuel system of a vehicle. Another advantage of the present invention is that the fuel pressure regulator assembly is specifically designed for use inside a fuel tank. Yet another advantage of the present invention is that the fuel pressure regulator assembly takes advantage of the “protected” environment and reduced temperature extremes inside the fuel tank. Still another advantage of the present invention is that the fuel pressure regulator assembly eliminates complex assembly machines and the assembly system is much smaller. A further advantage of the present invention is that the fuel pressure regulator assembly has a very lean overall assembly process and reduces the number of components over conventional fuel pressure regulators. Yet a further advantage of the present invention is that the fuel pressure regulator assembly has components of a size and shape to prevent improper assembly sequence. Still a further advantage of the present invention is that the fuel pressure regulator assembly requires fewer component parts providing simplified assembly, while meeting applicable automotive fuel system performance requirements. Another advantage of the present invention is that the fuel pressure regulator assembly eliminates a regulator adaptor and o-ring seats typically needed and combines the regulator adaptor and housing into one component. Yet another advantage of the present invention is that the fuel pressure regulator assembly uses an elastomer material at a sealing interface, resulting in a cost savings over conventional pressure regulators which use precision, highly polished and/or hardened steel surfaces to provide sealing at the valve/seat area. Still another advantage of the present invention is that the fuel pressure regulator assembly has a flexible membrane seal that seals against an injection molded seat, requiring no retention and providing hydraulic centering of a piston, requiring no fabric and providing sealing at the perimeter area.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of a fuel pressure regulator assembly, according to the present invention, illustrated in operational relationship with a fuel delivery module in a fuel tank.

FIG. 2 is a perspective view of the fuel pressure regulator assembly and fuel delivery module of FIG. 1.

FIG. 3 is a fragmentary elevational view of the fuel pressure regulator assembly and a portion of the fuel delivery module of FIG. 1.

FIG. 4 is a fragmentary elevational view of the fuel pressure regulator assembly of FIG. 1.

FIG. 5 is an exploded view of the fuel pressure regulator assembly of FIG. 1.

### DESCRIPTION OF THE PREFERRED EMBODIMENT

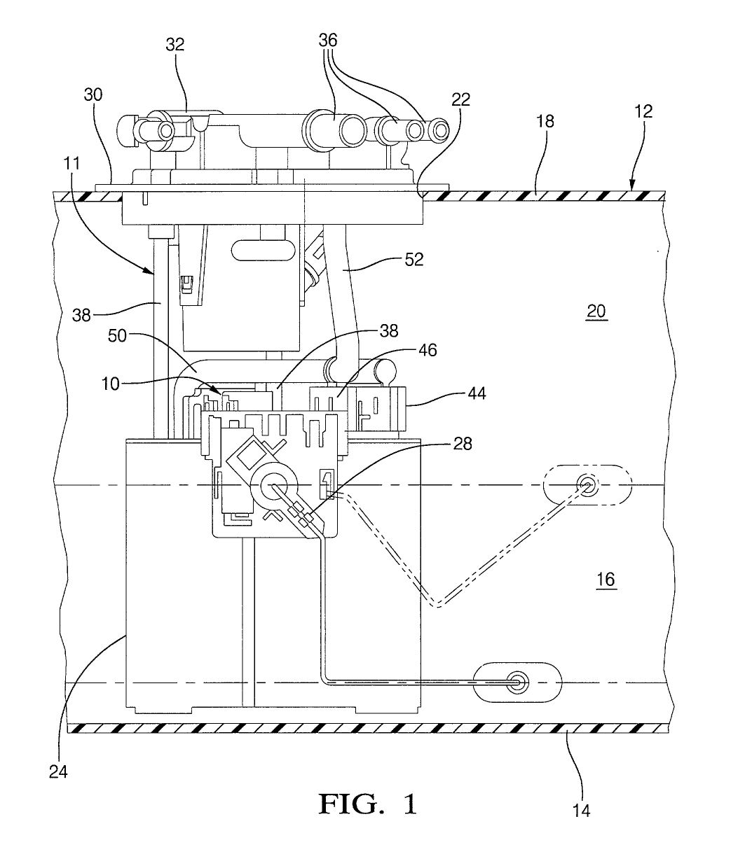

Referring to the drawings and in particular FIG. 1, one embodiment of a fuel pressure regulator assembly 10, according to the present invention, is shown for a fuel delivery module, generally indicated at 11, of a fuel system (not shown) of a vehicle (not shown). The fuel delivery module 11 is used with a fuel tank, generally indicated at 12, to hold liquid fuel. In this embodiment, the fuel tank 12 includes a bottom or base wall 14 and a side wall 16 around a periphery of the base wall 14 and extending generally perpendicular thereto. The fuel tank 12 also includes a top wall 18 extending generally perpendicular to the side wall 16 to form an interior chamber 20 to hold fuel. The top wall 18 includes an opening 22 therein for a function to be described. The fuel tank 12 is made of a rigid material, preferably a plastic material. It should be appreciated that the fuel tank 12 could be made of a metal material such as steel.

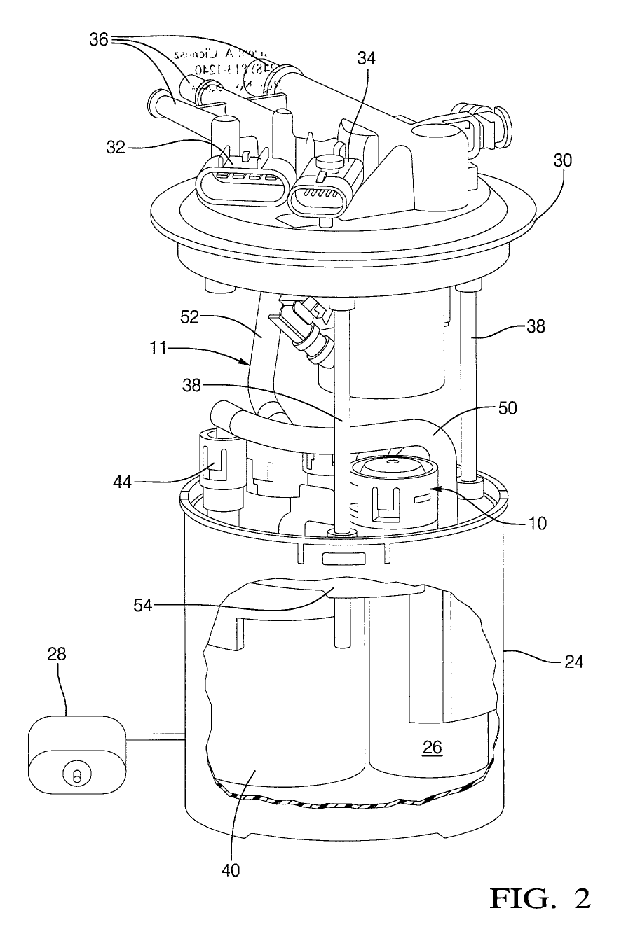

Referring to FIGS. 1 and 2, the fuel delivery module 11 is disposed in the interior chamber 20 of the fuel tank 12 and delivers fuel from the fuel tank 12 to an engine (not shown) of the vehicle. The fuel delivery module 11 includes a fuel reservoir 24 having an electrical fuel pump 26 mounted therein. The fuel delivery module 11 also includes a fuel level indication mechanism 28 such as a rheostat connected to the fuel reservoir 24 for indicating the level of the fuel inside the fuel tank 12. It should be appreciated that the fuel reservoir 24, fuel pump 0.26, and fuel level indication mechanism 28 are conventional and known in the art.

The fuel delivery module 11 includes a cover 30 to close the opening 22 in the fuel tank 12. The cover 30 includes an electrical connector 32 and a thermistor or onboard diagnostic sensor 34 connected to the cover 30. The cover 30 is made of a rigid material such as plastic, metal, or both. It should be appreciated that the cover 30 has a plurality of fuel tubes 36 connected to fuel lines (not shown).

The fuel delivery module 11 further includes a plurality of guide rods or tubes 38 to mechanically connect the cover 30 with the fuel reservoir 24. The fuel delivery module 11 includes a pump harness (not shown) electrically connected to the electrical connector 32 and the fuel pump 26. It should be appreciated that the fuel pump 26 is electrically connected to a vehicle electrical system (not shown) through the pump harness and the electrical connector 32.

Referring to FIGS. 1 through 3, the fuel delivery module 11 includes a fuel filter 40 disposed in the fuel reservoir 24 and cooperating with the fuel pump 26. The fuel filter 40 includes an upper end cap 42 having at least one, preferably a plurality of integral quick connectors 44, 46, and 48 extending outwardly therefrom. The quick connector 44 is fluidly connected via a conduit 50 to the fuel pump 26. The quick connector 46 is fluidly connected via a conduit 52 to an engine (not shown) of the vehicle. The quick connector 48 is fluidly connected to the fuel pressure regulator assembly 10 to be described.

The fuel filter 40 also includes a retainer 54. The retainer 54 has a cavity wall 56 extending axially and annularly to form a cavity 58. The fuel filter 40 is disposed in the cavity 58 and is snap-fitted therein by the cavity wall 56. The retainer 54 also has an annular sidewall 60 connected to the cavity wall 56. The sidewall 60 extends axially and has a flange 62 extending generally perpendicular thereto that overlaps a top edge of the reservoir 24. The retainer 54 is made of a plastic material. The retainer 54 is a monolithic structure being integral, unitary, and one-piece.

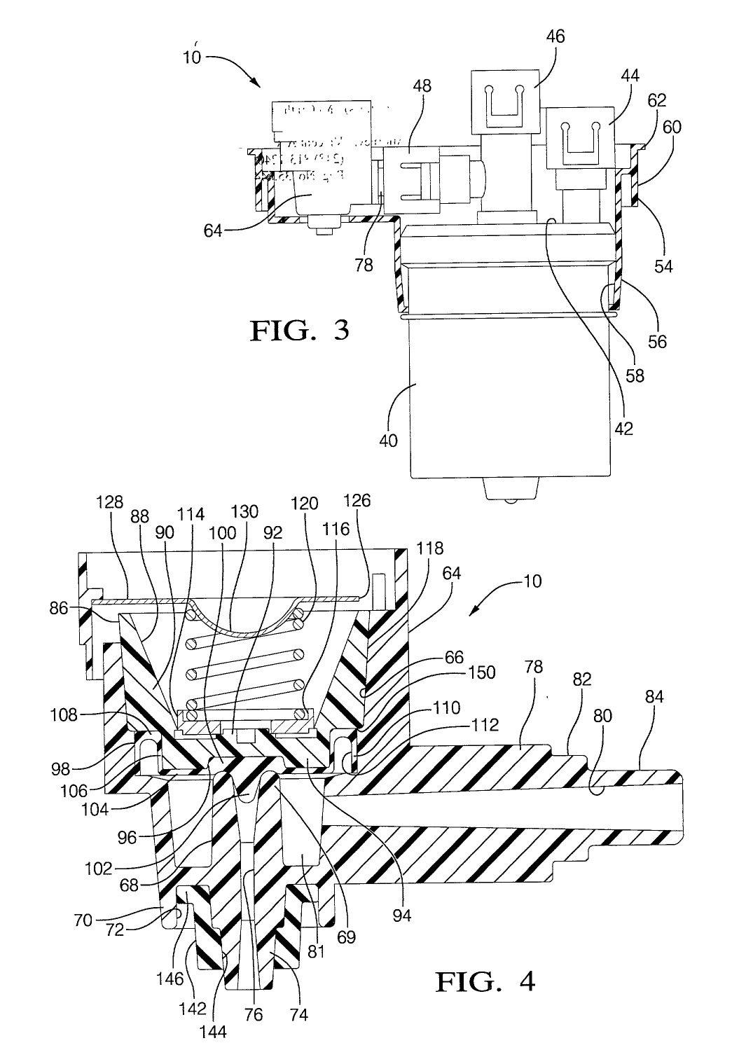

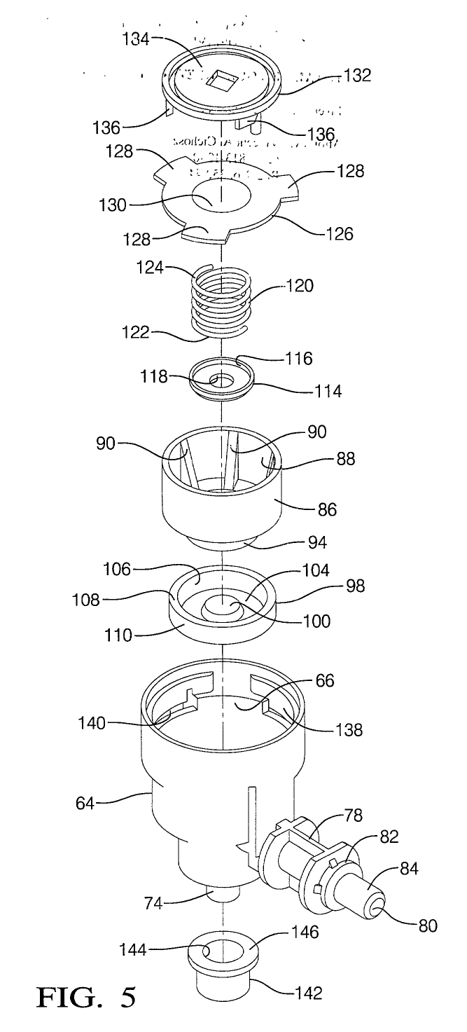

Referring to FIGS. 3 through 5, the fuel delivery module 11 includes the fuel pressure regulator assembly 10, according to the present invention, disposed in the fuel reservoir 24 and cooperating with the fuel filter 40 and the fuel pump 26. The fuel pressure regulator assembly 10 is disposed in the retainer 54 and snap fits via the quick connector 48 to the fuel filter 40. The fuel pressure regulator assembly 10 also cooperates with a by-pass fuel tube (not shown) extending axially through the retainer 54 from the reservoir 24.

Referring to FIGS. 3 through 5, the fuel pressure regulator assembly 10 includes a regulator body or housing 64. The housing 64 is generally cylindrical and circular in shape. The housing 64 has a first cavity 66 extending axially inward. The housing 64 has a first projection 68 extending axially into the first cavity 66 to form a valve seat 69 for a function to be described. The housing 64 has a side wall 70 extending axially and circumferentially to form a second cavity 72. The housing 64 has a second projection 74 extending axially into the second cavity 72 for a function to be described. The housing 64 has a first passageway 76 extending axially through the first projection 68 and the second projection 74. The housing 64 has a connector portion 78 extending radially therefrom. The connector portion 78 has a second passageway 80 extending therethrough and communicating with a chamber 81 formed in the first cavity 66. The connector portion 78 has a first reduced diameter portion 82 extending axially and a second reduced diameter portion 84 extending axially from the first reduced diameter portion 82. The housing 64 is made of a rigid material such as plastic, preferably polyphenylene sulfide (PPS) The housing 64 is molded by a conventional plastic injection molding process. The housing 64 is a monolithic structure being integral, unitary, and one-piece. It should be appreciated that the housing 64 is manufactured from either an injection moldable or thermal set polymer to allow surface finishes suitable for sealing without the use of secondary operations. It should also be appreciated that the housing 64 acts as a carrier for the other components.

The fuel pressure regulator assembly 10 also includes a movable piston 86 disposed in the first cavity 66 of the housing 64. The piston 86 is generally cylindrical and circular in cross-sectional shape. The piston 86 has a cavity 88 extending axially inward from one end. The piston 86 also has a plurality of ribs 90 disposed in the cavity 88 and spaced circumferentially thereabout. The ribs 90 are generally tapered and triangular in shape. The piston 86 has a projection 92 extending axially into the cavity 88. The projection 92 is generally circular in shape for a function to be described. The piston 86 also has a base 94 extending axially. The base 94 is generally circular in shape and has a diameter less than a main portion of the piston 86. The base 94 has a cavity 96 extending axially therein for a function to be described. The piston 86 is made of a rigid material such as plastic, preferably PPS. The piston 86 is a monolithic structure being integral, unitary, and one-piece. It should be appreciated that the piston 86 is set into the cavity 66 of the housing 64, which interfaces with minimal clearance to allow vertical movement of the piston 86 without significant friction. It should also be appreciated that the injection molding process used to form both the piston 86 and the housing 64 allows controlled and optimized surface finishes creating an ideal sealing environment.

The fuel pressure regulator assembly 10 includes a flexible membrane seal 98 disposed in the housing 64. The seal 98 is generally circular in shape. The seal 98 has a base 100 that is generally circular in shape. The base 100 has a projection 102 extending axially therefrom to form a valve. The seal 98 has a first wall 104 extending radially from the base 100. The first wall 104 has a thickness less than the base 100. The seal 98 also has a second wall 106 extending axially from the first wall 104 and a third wall 108 extending radially from the second wall 106. The seal 98 has a fourth wall 110 extending axially from the third wall 108 to form an annular groove 112 between the second wall 106, third wall 108, and fourth wall 110. It should be appreciated that the walls 106, 108, and 110 form a convolute.

The seal 98 is disposed in the first cavity 66 of the housing 64 between the piston 86 and the first projection 68 of the housing 64. The base 100 is disposed in the cavity 96 of the piston 86 and the projection 102 is disposed in the first passageway 76 adjacent the valve seat 69 of the first projection 68 and the second wall 106 is disposed adjacent the base 94 of the piston 86. The seal 98 is made of a flexible material such as an elastomeric material or a flexible injection moldable polymer, preferably Viton, NBR, or trifluoroethylene (TFE). The seal 98 is a monolithic structure being integral, unitary, and one-piece. It should be appreciated that the seal 98 fits between the face of the piston 86 and cavity 66 of the housing 64 to seal at the perimeter thereof and also at valve/seat region near center of the piston 86. It should also be appreciated that sealing between the high pressure side of the regulator assembly 10 and the low pressure side of the regulator assembly 10 is achieved by the seal 98. It should further be appreciated that the hydraulic pressure of the high pressure fuel helps in sealing the gap between the piston 86 and the housing 64 by forcing the extremities of the convolutes of the seal 98 against the inner diameter of the housing 64. It should also be appreciated that the substantial height of the convolute of the seal 98 allows the hydraulic forces to be balanced and the piston 86 to be centered. It should further be appreciated that since the sealing of the high pressure side and the low pressure side of the regulator assembly 10 is achieved by the seal 98 which is pressed against the side of the housing 64 by hydraulic pressure, the regulator assembly 10 has a consistent pressure set point under variable temperatures and material swell conditions resulting from exposure to various fuels.

The fuel pressure regulator assembly 10 also includes a lower spring plate 114 disposed in the housing 64. The spring plate 114 is generally circular in shape. The spring plate 114 has a cavity 116 extending axially therein. The spring plate 114 also has an aperture 118 extending axially therethrough and communicating with the cavity 116. The spring plate 114 is disposed in the cavity 88 of the piston 86 and the projection 92 of the piston 86 engages the aperture 118. The spring plate 114 is made of a rigid material such as metal, preferably ferrous or stainless steel. The spring plate 114 is a monolithic structure being integral, unitary, and one-piece. It should be appreciated that the spring plate 114 has a low profile to assist in the assembly process.

The fuel pressure regulator assembly 10 further includes a spring 120 disposed in the housing 64. The spring 120 is of a coil type. The spring 120 is disposed in the cavity 88 of the piston 86 and has a first end 122 disposed in the cavity 116 of the spring plate 114. The spring 120 extends axially to a second end 124 for a function to be described. The spring 120 is made of a spring material such as metal, preferably ferrous or stainless steel. It should be appreciated that the spring 120 is a monolithic structure being integral, unitary, and one-piece.

The fuel pressure regulator assembly 10 includes an upper spring or cap plate 126 disposed in the housing 64. The cap plate 126 is generally circular in shape. The cap plate 126 has at least one, preferably a plurality of tabs 128 extending radially outwardly and spaced circumferentially about a periphery thereof for a function to be described. The cap plate 126 also has a projection 130 extending axially toward the spring 120. The projection 130 is generally hemispherical in shape. The cap plate 126 is made of a rigid material such as metal, preferably ferrous or stainless steel. The cap plate 126 is a monolithic structure being integral, unitary, and one-piece. It should be appreciated that the projection 130 is disposed within the second end 124 of the spring 120 to center the spring 120. It should also be appreciated that the lower spring plate 114, spring 120, and upper spring plate 126 combine to form a spring biasing mechanism for the piston 86.

The fuel pressure regulator assembly 10 also includes a cap or cover 132 disposed over one end of the housing 64. The cover 132 is generally circular in shape. The cover 132 has a base 134 and at least one, preferably a plurality of teeth or flanges 136 extending from the base 134. The cover 132 sets into the cap plate 126 and when rotated causes the cap plate 126 to rotate along three ramped shelves 138 in the housing 64, gradually compressing the spring 120 to a desired final spring height, providing desired pressure set point for the regulator assembly 10. The tabs 128 of the cap plate 126 extend through slots 106 in the housing 64. The flanges 136 on the cover 132 lock into the slots 106 on the housing 64, preventing any further movement of the cover 132. The cover 132 is made of a rigid material such as plastic, preferably an acetal. The cover 132 is a monolithic structure being integral, unitary, and one-piece. It should be appreciated that the cover 132 keeps particulate contamination out of the working mechanism of the regulator assembly 10.

The fuel pressure regulator assembly 10 further includes a seal or bushing 142 disposed about the second projection 74 of the housing 64. The seal 142 is generally tubular in shape with a generally circular cross-sectional shape. The seal 142 has an aperture 144 extending axially therethrough to receive the projection 74 and a flange 146 extending radially outwardly at one end thereof and is disposed in the cavity 72 of the housing 64. The seal 142 is made of a rigid material such as plastic. The seal 142 is a monolithic structure being integral, unitary, and one-piece. It should be appreciated that the seal 142 is used to help contain the by-passed fuel between the outlet of the regulator assembly 10 and the mating component such as the reservoir 24 of the fuel delivery module 11. It should also be appreciated that the seal 142 provides the additional function of decoupling the regulator assembly 10 from mating components to minimize the transmission of vibration.

Referring to FIG. 4, the fuel pressure regulator assembly 10 is shown as assembled. The cover 142 is used to minimize entrapment of “dirt” inside the regulator assembly 10 and to hold the upper spring or cap plate 126 in its proper position. It should be appreciated that the assembly sequence is linear or inline as all components set into the cavity 66 of the housing 64 about a common centerline.

In operation, the spring 120 biases the piston 86. Fuel enters through the passageway 80 in the connector portion 78 of the housing 64 and is presented to the underside of the piston 86 and the seal 98 through chambers 81. As the fuel pressure in chambers 81 increases to the point where it overcomes the spring bias acting against the piston 86, the piston 86 moves upward allowing fuel to flow from the chambers 81 past the valve seat 69 and into the passageway 76. When sufficient fuel has flowed through the passageway 76 to allow the pressure to drop to the point where the spring bias overcomes the fuel pressure, the piston 86 moves downward, and the seal 98 closes off the flow through the passageway 76. It should be appreciated that small axial movement of the piston 86 in either the up or down direction controls the flow of fuel through the valve seat 69 by opening or restricting the opening to the passageway 76 within the valve seat 69 with the seal 98. It should also be appreciated that the fuel pressure is “regulated” by this controlled release of fuel. It should be appreciated that the bias of the spring 120 determines the pressure at which the regulator assembly 10 will operate.

When system pressure is zero, the piston 86 travels to its closed or at-rest position. This position is defined by substantial contact surface between the piston 86 and the housing 64 around the full lower perimeter of the piston 86. This contact occurs outside the region occupied by the seal 98. Compression of the seal 98 occurs only at the seat area near the center of the piston 86. The magnitude of the compression is controlled by clearance between the piston 86 and the valve seat 69 to achieve optimal sealing yet keep the unit loading of any chosen elastomer material within its specified range to maximize material life. Sealing at the perimeter interface occurs as the substantial vertical side wall area of the seal 98 is acted on by pressurized fluid. It should be appreciated that the substantial vertical wall areas create a centering force, keeping the piston 86 centered and balancing all hydraulic and mechanical forces.

Piston travel is minimized since balanced fluid pressure causes a “straight up” movement of the piston 86. This “straight up” movement yields the largest possible fuel discharge area for any given height of the piston 86. Over-compression of the seal 98 and the possible “cutting” of the seal 98 by the valve seat are achieved by preventing the full force of the spring 120 to act on the seal 98 in a downward direction. This is achieved by allowing the edge of the piston 86 to bottom out against a step 150 on the housing 64. Upward travel of the piston 86 is limited to the point where the upper edge of the piston 86 meets the outer edge of the spring plate 126. It should be appreciated that the “protected” location inside the fuel tank 12 and the absence of having to hold the seal 98 under a compressive load allows the use of materials other than steel. It should also be appreciated that reduced temperature extremes allow the use of materials such as injection moldable or thermal set polymers.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A fuel pressure regulator assembly for a fuel delivery module of a fuel system of a vehicle comprising:
a housing having a cavity therein and a valve seat extending into said cavity and a passageway extending through said valve seat;
a movable piston disposed in said cavity of said housing;
a seal connected to said piston and disposed between said piston and said valve seat; and
a biasing mechanism disposed in said cavity to bias said piston and said seal toward said valve seat to close said passageway.

2. A fuel pressure regulator assembly as set forth in claim 1 wherein said biasing mechanism includes a spring disposed within said piston.

3. A fuel pressure regulator assembly as set forth in claim 2 wherein said biasing mechanism includes a lower spring plate disposed within said piston and cooperating with a lower end of said spring.

4. A fuel pressure regulator assembly as set forth in claim 2 wherein said biasing mechanism includes an upper spring plate disposed within and cooperating with said housing and an upper end of said spring.

5. A fuel pressure regulator assembly as set forth in claim 1 including a cover disposed within said cavity of said housing to cover said cavity.

6. A fuel pressure regulator assembly as set forth in claim 1 wherein said seal has a projection extending into said passageway.

7. A fuel pressure regulator assembly as set forth in claim 1 wherein said housing includes a projection extending into said cavity and forming said valve seat and a chamber disposed between said projection and said seal.

8. A fuel pressure regulator assembly as set forth in claim 1 wherein said seal is made of a flexible material.

9. A fuel pressure regulator assembly as set forth in claim 8 wherein said flexible material is an elastomeric material.

10. A fuel pressure regulator assembly as set forth in claim 1 wherein said housing is made of a plastic material.

11. A fuel delivery module comprising:
a fuel reservoir adapted to be disposed in an interior chamber of a fuel tank;
a fuel pump disposed in said fuel reservoir and adapted to pump fuel from the fuel tank to an engine of a vehicle;
a fuel filter disposed in said fuel reservoir;
a fuel pressure regulator assembly disposed in said fuel reservoir and connected to said fuel filter and said fuel pump, said fuel pressure regulator assembly comprising a housing having a cavity therein and a valve seat extending into said cavity and a passageway extending through said valve seat, a movable piston disposed in said cavity of said housing, a seal connected to said piston and disposed between said piston and said valve seat, and a biasing mechanism disposed in said cavity to bias said piston and said seal toward said valve seat to close said passageway.

12. A fuel delivery module as set forth in claim 11 wherein said biasing mechanism includes a spring disposed within said piston.

13. A fuel delivery module as set forth in claim 12 wherein said biasing mechanism includes a lower spring plate disposed within said piston and cooperating with a lower end of said spring.

14. A fuel delivery module as set forth in claim 12 wherein said biasing mechanism includes an upper spring plate disposed within and cooperating with said housing and an upper end of said spring.

15. A fuel delivery module as set forth in claim 11 including a cover disposed within said cavity of said housing to cover said cavity.

16. A fuel delivery module as set forth in claim 11 wherein said seal has a projection extending into said passageway.

17. A fuel delivery module as set forth in claim 16 wherein said housing includes a projection extending into said cavity and forming said valve seat and a chamber disposed between said projection and said seal.

18. A fuel delivery module as set forth in claim 11 wherein said seal is made of a flexible material.

19. A fuel delivery module as set forth in claim 11 wherein said housing is made of a plastic material.

20. A fuel system for a vehicle comprising:
a fuel tank having an interior chamber and an opening therein;
a fuel reservoir disposed in said interior chamber of said fuel tank;
a fuel pump disposed in said said fuel reservoir to pump fuel therefrom to an engine of the vehicle;
a fuel filter disposed in said fuel reservoir;
a fuel pressure regulator assembly disposed in said fuel reservoir and connected to said fuel filter and said fuel pump, said fuel pressure regulator assembly comprising a housing having a cavity therein and a valve seat extending into said cavity and a passageway extending through said valve seat, a movable piston disposed in said cavity of said housing, a seal connected to said piston and disposed between said piston and said valve seat, and a biasing mechanism disposed in said cavity to bias said piston and said seal toward said valve seat to close said passageway.
